(19) United States
(12) Patent Application Publication
(10) Pub. No.: US 2012/0043358 A1
(43) Pub. Date: Feb. 23, 2012

(54) MULTI-COMPARTMENT FISHING BACKPACK

(76) Inventor: Shawn Kelly, Beaumont, CA (US)

(21) Appl. No.: 12/861,260

(22) Filed: Aug. 23, 2010

(51) Int. Cl. A45F 3/04; A01K 97/06; A01K 97/08; A45F 3/08

(52) U.S. Cl. 224/148.2; 224/629; 224/653; 224/637; 224/650; 43/54.1

(57) ABSTRACT

The invention is a fishing backpack with an external metal frame, lower back support, and storage compartments for fishing supplies and bulk drinking water. These storage compartments are used to carry tackle and/or tackle boxes, food, fishing rods and reels, fishing nets, and bulk liquid storage in several compartments. The invention allows the users to carry everything they need for a fishing expedition in a convenient all-in-one pack that is also easily transportable in a truck or cab of a car.

### FIELD OF INVENTION

This invention relates generally to backpacks, and more specifically to a fishing backpack with an external metal frame, lower back support, and storage compartments for fishing supplies and water. These storage compartments are intended to store tackle and/or tackle boxes, food, fishing rods and reels, fishing nets, and bulk liquid.

### BACKGROUND

Fishing is a fun and relaxing hobby for millions of individuals and fishing equipment carriers have been developed to allow for easier transportation for enthusiasts. While relatively simple backpacks are sufficient to carry some of the more basic fishing supplies, such as tackle and polls, fishermen often need to carry large amounts of equipment and supplies, which may include nets, multiple tackle boxes, food, and bulk drinking water. While multifunctional backpacks with numerous storage compartments, have been available now for several years, they lack the ability to contain the oddly-shaped fishing poles, tackle boxes, and large amounts of drinking water that are not typically able to be carried in a standard backpack.

Several fishing backpacks have been developed that seek to contain some of the fishing equipment that might be needed by a fisherman, in an effort to help a fisherman carry, in as few trips as possible, all of the equipment he needs. It is necessary for the backpack to support the often heavy weight that the fisherman must carry on his back through a long hike to find the ideal fishing spot. These currently available backpacks mimic a standard multi-compartment backpack or have repurposed a standard container to mimic the functionality of a backpack.

Regarding multi-compartment backpacks that might be used for fishing, U.S. Pat. Nos. 6,217,113, issued to Knatz, 5,275,316 issued to Kish, 6,052,939, issued to McClain, and 5,975,393, issued to Bellamy, disclose fishing backpacks with a pole holder that are able to contain a tackle box, and a small amount of food and beverages. Additionally, and more specifically, these references disclose a pack that combines one or more pole holders and a tackle box carrier combined within a backpack. Importantly, however, the references lack several of the compartments and features that an avid fisherman may want during his or her fishing trip, including a bulk drinking compartment, a drinking tube, removable food or beverage storage pouches, and a waist belt for additional support.

Specifically, the Knatz reference discloses a backpack with a seat member with backpack compartments that can be further partitioned. Although the Knatz backpack discloses a reinforced seat member that is attached to the backpack main portion, the reinforcement is provided to support the weight of the user while they are using the seat member, not to support the extra weight in the backpack while the user is wearing the backpack. Additionally, the hollow members that form the legs of the seat may act as fishing pole holders, but the Knatz reference lacks any suggestion or motivation to incorporate this function with carrying other necessary fishing items in the backpack.

Furthermore, although the Kish reference discloses a backpack that includes a removable storage compartment or fishing gear side pockets, importantly, the Kish reference lacks any suggestion to use the removable storage compartments for food, beverages, bulk fluid storage, or a fishing net. Kish also fails to suggest that the side pockets are designed to carry common fishing gear.

Several other references disclose various non-backpack receptacles used to carry fishing poles, tackle boxes, or fishing gear. These references include: U.S. patent application Ser. No. 09/951,593 filed by Barnes; U.S. Pat. No. 4,529,112, issued to Miller; and U.S. Pat. No. 3,678,611, issued to Files. In addition to these references not being backpacks, they also fail to disclose many important features of the present invention.

For example, the Barnes reference discloses a fishing rod carrier with an elongated frame that is adjustable in length. At each end of the frame is a disk with several radial slots about the circumference. The slots are of a size to accept the shaft or butt of a fishing rod. On each disk there is a belt surrounding the circumference of the disk. The belts are attached near each midpoint leaving free ends that can be fastened together temporarily to span the radial slots and hold the rod in place. However, Barnes discloses a plastic tubular support structure, preferably made of PVC pipe, for holding and transporting fishing rods that are in the vertical, upright position.

The Miller reference discloses a carrier for fishing rods and tackle. The fishing rod holders are mounted on the tackle box for holding fully assembled fishing rods and reels or disassembled sections of one or more fishing rods thereon. One or more of the holders are channel-shaped for securing the fishing rod and reel therein and have an elongated recess for receiving a fishing rod, reel, or other devices that may extend over the recess.

The Files reference discloses a device, which is not a backpack, that holds fishing poles, tackle boxes and other fishing gear. Files discloses a fishing tackle carrier which has a floating container with removable caps at the ends and a compartment with a hinged cover containing superimposed trays for lures and other fishing tackle. The carrier remains buoyant even through the central compartment is open for access to the trays.

In sum, although the Barnes, Miller, and Files references disclose various adaptable fishing gear containers, these containers are not backpacks and they lack the functionality to carry all of the gear that is needed for a fishing expedition.

Regarding references that disclose backpacks or bags that are for carrying tackle boxes, including: U.S. Pat. No. 4,151,938 issued to Barker; U.S. Pat. No. 3,181,751, issued to Wilson; U.S. Pat. No. 4,372,073 issued to Goldman; and U.S. Pat. No. 6,435,390, issued to Abramowicz. The Barker reference discloses a handbag for carrying fishing tackle. However, the Barker bag has no storage for food or beverages, and discloses only front pockets that are designed to be worn in front by the fisherman like an apron or fanny pack. The Barker reference is very simplistic and fails to disclose many key features of the present invention.

Similarly, the Goldman reference discloses an improved fishing tackle storage apparatus having a lure mounting pad, but that fails to disclose many of the important storage compartments of the present invention. The Goldman pad is fabricated from a sheet of foamed elastomeric material adapted for detachably receiving the hook of a hook-type fishing lure and having a protective cover flap substantially resistant to hook penetration. The protective cover flap is adapted to cover the lure mounting pad and associated hooks. The fishing tackle storage apparatus is made compact for transport by rolling into a cylindrical shape. Thus, the Goldman pad is very limited and does not teach or suggest such important features as being an all in one fishing backpack or having a bulk liquid storage.

The Abramowicz reference discloses a backpack that consists of a rigid box with a hinged lid for access downwardly into and having a canopy mounted on the hinged lid of the pack which define an accessible storage compartment the lid. A pair of shoulder straps is mounted to the front side of the canopy and box. Similar to Goldman, the Abramowicz reference is also very limited and fails to disclose important features as being an all in one fishing backpack or having a bulk liquid storage.

Other types of references disclose carriers that are specifically designed to hold and protect rods and reels, including: U.S. Pat. No. 4,136,478, issued to Wycosky; U.S. Pat. No. 6,343,728, issued to Carbone; U.S. Pat. No. 5,664,721, issued to Homeyer; and U.S. Pat. No. 2,709,544, issued to Barringer. Importantly these references are not directed at bags that are meant to transport, via hiking or camping, the entirety of the gear and supplies that are necessary for a day of fishing. For example, the Carbone reference discloses a support bag for the enclosure and controlled support of a fishing rod and reel arrangement. This design holds and protects the rod, but fails to teach or disclose using the bag as a back pack on a fishing expedition. Furthermore, the Homeyer reference discloses a backpack-style carrier for transporting sporting equipment such as a rifle, a shotgun, an archery bow, or a fishing rod. It is specifically not designed to include provisions and tackle. The Barringer reference discloses a fishing rod and tackle carriers which are supported on one side of a fisherman by a shoulder strap. The basic tackle box design of the Barringer reference is not compatible with an all in one fishing back pack that has a bulk water storage.

Other types of references disclose drinking apparatuses to wear on a user's back. One such reference is U.S. Pat. No. 6,199,729, issued to Drzymkowski, discloses such an apparatus for a bicyclist that provides a liquid reservoir, a delivery tube with at least one detachable mouthpiece, and a chest strap. However, the Drzymkowski reference fails to disclose added compartments or a support structure for the weight of the liquid reservoir.

Similarly, Camelbak® sells backpacks that contain drinking tubes through their website (http://camelbak.com/en/sports-recreation/spring-summer-hydration-packs.aspx). These backpacks disclose the combination of a storage backpack, a bulk water storage compartment, and a flexible drinking tube. However, the Camelbak® backpacks are not made for fishermen nor are they disclosed in combination with fishing backpacks. They are neither designed nor built to carry multiple fishing supplies on a fisherman's back, especially fishing poles and rods, but provide only drinking water to the user through a flexible drinking tube. There is no suggestion to combine these backpacks to enhance the storage capabilities for standard-sized fishing equipment.

Regarding references that disclose backpacks or bags with fishing net storage, include: U.S. Pat. No. 6,036,067, issued to Alcorn; U.S. patent application Ser. No. 11/453,328, issued to Looney; U.S. Pat. No. 2,473,977, issued to Tutton; and U.S. Pat. No. 2,816,390, issued to Vaughn et al. These references fail to disclose most of the important features of the present invention. For example, the Alcorn reference discloses a carrier adapted for a fish landing net. The fish landing net carrier may include a number of straps, handles, and hooks for enabling the fisherman to easily transport the fish landing net within the carrier. Also, the carrier may include a number of fishing accessories and a number of fishing poles, rods, or pole caddies contemporaneously either by hand, over-the-shoulder, or attached to a backpack. Importantly, the Alcorn reference fails to disclose a pack that carries tackle, food, or bulk liquid, and fails to include a support frame.

The Looney reference discloses a fishing tackle carrier and, more specifically, provides an improved and novel type of fishing bait carrier. The device includes a main body with a variety of pockets and pouches. Attached to the main body is an expandable pouch with a liner to hold live bait. Additionally, cylindrical sleeves are attached in main body seams to provide a holding compartment for a fishing rod. The Tutton reference discloses a similar carrier that additionally floats, and does not permit access to the interior while floating. Although these tackle box references, with a net storage compartment, are versatile and useful, they fail to disclose a fishing backpack with food and liquid storage, and a support frame.

Thus, there remains a long felt need in the art for a fishing backpack for easily transporting all the fishing gear and supplies needed for a fishing expedition, hiking, or camping.

### BRIEF SUMMARY OF THE INVENTION

To minimize the limitations in the cited references, and to minimize other limitations that will become apparent upon reading and understanding the present specification, the present invention discloses a fishing backpack wherein the backpack is supported by an external frame and lower back support and contains several compartments for storing fishing gear, tackle, food, supplies, and bulk water.

One embodiment of this invention is a fishing backpack comprising: a backpack. The backpack is comprised of one or more shoulder straps; a rigid frame; one or more storage compartments; and one or more fishing rod holders. Preferably the backpack also has one or more fishing rod clasps; wherein the one or more fishing rod holders secure a fishing rod base of a fishing rod and wherein the one or more fishing rod clasps secure an upper portion of the fishing rod. The storage compartments are further comprised of: a primary tackle storage compartment; a food storage compartment; and a bulk liquid storage compartment. The fishing backpack is further comprised of: a net storage compartment; wherein the net storage compartment is removable from and reattachable to the backpack. Preferably the bulk liquid storage compartment has one or more drinking tubes; wherein the one or more drinking tubes have a valve that allows a user to control access to a liquid in the bulk liquid storage compartment. The backpack may also be further comprised of: one or more drinking tube clasps, which are preferably attached to the shoulder straps. The backpack may also have a lower back support; and a waist belt; wherein the waist belt secures the backpack to the user. Preferably the rigid frame is further comprised of: one or more support bars; wherein the one or more support bars are on a back side of the backpack and provide rigid support for the backpack. The fishing rod clasps may be tension and friction clasps (or spring-loaded) and are preferably fixedly attached to the rigid frame such that the user may snap the fishing rod into and out of the fishing rod clasps. The storage compartments may also include one or more secondary tackle compartments and one or more side compartments. The backpack may also have a carrying handle.

Another embodiment of the invention is a fishing backpack comprising: a backpack; wherein the backpack is comprised of one or more shoulder straps; a rigid frame; one or more storage compartments; one or more fishing rod holders; one or more fishing rod clasps; a net storage compartment; one or more drinking tubes; one or more drinking tube clasps; a lower back support; a waist belt; one or more support bars; and a carrying handle. The fishing rod holders secure a fishing rod base of a fishing rod and wherein the one or more fishing rod clasps secure an upper portion of the fishing rod. The storage compartments are comprised of a primary tackle storage compartment; a food storage compartment; a bulk liquid storage compartment; one or more secondary tackle compartments; and one or more side compartments. The net storage compartment is removable from and reattachable to the backpack. The drinking tubes have a valve that allows a user to control access to a liquid one or more shoulder straps. The waist belt secures the backpack to the user. The support bars are on a back side of the backpack and provide rigid support for the backpack. The fishing rod clasps are tension and friction clasps or spring-loaded and are fixedly attached to the rigid frame such that the user may snap the fishing rod into and out of the one or more fishing rod clasps.

Another embodiment of the invention is a fishing backpack comprising: a backpack; wherein the backpack is comprised of one or more shoulder straps; one or more tackle storage compartments; one or more food storage compartments; one or more bulk liquid storage compartments; one or more fishing rod cups; and one or more fishing rod clasps. The fishing rod cups secure a fishing rod base of a fishing rod and wherein the one or more fishing rod clasps secure an upper portion of the fishing rod. Preferably the backpack also includes a net storage compartment; wherein the net storage compartment is removable from and reattachable to the backpack. Preferably the bulk liquid storage compartment is further comprised of: one or more drinking tubes and one or more drinking tube clasps. The drinking tubes may have a valve that allows a user to control access to a liquid in the bulk liquid storage compartment and the drinking tube clasp is attached to the one or more shoulder straps. Preferably the backpack has a rigid frame and one or more support bars; wherein the rigid frame and the support bars provide structure to the backpack and allow the user to carry more weight in the backpack. The backpack preferably has a lower back support and a waist belt; wherein the waist belt secures the backpack to the user. The backpack preferably includes a carrying handle at the top of the backpack. The one or more fishing rod clasps are preferably tension and friction (or spring-loaded) clasps and are fixedly attached to the rigid frame such that the user may snap the fishing rod into and out of the one or more fishing rod clasps when the fishing rod is in the one or more fishing rod cups.

The clasps allow the user to easily snap in and out the fishing poll. The tension, friction, or spring-loaded clasps secure the fishing rods and reels to the fishing backpack to limit its movement in the horizontal direction when the fishing backpack is upright. The fishing poles are more accessible when they are supported by the clasp. The fisherman can gently pull the fishing pole away from the clasp to remove it from the fishing backpack. The fishing pole is vertically stabilized by a holder, platform, cup, or hollow tube that restricts the pole from falling to the ground or escaping from the fishing backpack if it tips over.

The external rigid frame is preferably manufactured from a material that is durable and lightweight, such as aluminum, steel, titanium, plastic, wood, and fiberglass. The external frame generally outlines the external silhouette of the fishing backpack. This ensures that the contents inside the fishing backpack are protected and the external frame can provide extra support without being lopsided on the users back.

The lower back support may be padding to provide lumbar support for the fisherman while wearing the fishing backpack. The waist strap is distally attached to the lower back support such that the strap circumvents the waist of the fisherman and limits the movement of the fishing backpack and helps balance the backpack on the wearer. Alternatively, the waist strap can be a clasp or clip to the fisherman's clothes to similarly limit the movement of the fishing backpack away from the fisherman's body and thereby provide additional support for the heavy load.

One or more compartments for storing fishing supplies may be located within and around the fishing backpack. The compartments facilitate storage for common fishing supplies like tackle, lures, and reels or supplies that fishermen bring on a fishing trip like food, drinks, cameras, cellular phones, and medical supplies. Each compartment may contain additional compartments for smaller fishing items. These smaller compartments can be enclosed in a separate container that fits within the fishing backpack storage compartment.

One or more compartments for storing water may also be included within the fishing backpack. The fisherman can easily access one or more water compartments through one or more flexible drinking tubes and a corresponding mouthpiece. The water compartment may be located near the top of the fishing backpack when the backpack is sitting upright so that the flexible drinking tube can be shorter and save on manufacturing costs. The water compartment may be fixedly attached to the exterior or interior of the fishing backpack. If the water compartment is attached to the exterior of the fishing backpack, it may be sown or clasped on one or more sides so that the water compartment remains stable through strenuous hikes but still allows access to the interior of the fishing backpack. If the water compartment usually in the interior of the fishing backpack and it may be self contained to ensure stability and not interfere with the other compartments for storage. The compartment for storing water is a waterproof and flexible bottle or pouch and may be removable or completely integrated with the backpack. The mouthpiece may be detachable or fixedly attached to the flexible drinking tube so that the mouthpiece does not fall off when the backpack is moved vigorously.

Another embodiment of this invention is a fishing backpack that comprises: an aluminum frame; a waist belt; one or more support bars; one or more hollow cylinders; and one or more clasps. The aluminum frame is secured to the backpack and outlines the exterior of the fishing backpack. The waist belt is fixedly attached to the lower half of the fishing backpack in order to limit the movement of the fishing backpack and secure the fishing backpack to a fisherman's body.

One or more support bars buttress the stability of the fishing backpack. A support bar in one embodiment may be distally attached to the exterior of the fishing backpack so that the support bar is parallel to the ground when the fishing backpack is upright. The opposite end of the support bar that is not attached to the exterior of the fishing backpack is attached to the outside of the one or more hollow cylinders. The hollow cylinders or fishing rod cups or fishing rod holders support the fishing rods and reels parallel to the side of the fishing backpack. In this embodiment, the one or more clasps are fixedly attached to the one or more support bars in order to secure fishing rods and reels. Another support bar in this embodiment may be distally attached to the external aluminum frame so that the support bar is perpendicular to the ground when the fishing backpack is upright and both ends of the support bar are attached to the external aluminum frame.

Another embodiment is a fishing backpack comprising: an aluminum frame; one or more compartments for liquid; and one or more flexible drinking tubes. The aluminum frame supports the structure of the fishing backpack; wherein the one or more compartments for liquid are reinforced with synthetic material to enclose liquid; wherein the one or more flexible drinking tubes contain a mounting end and a terminal end such that the mounting end is fixedly attached to a hole in the one or more compartments for liquid; wherein the terminal end of the one or more flexible drinking tubes is accessible to the mouth of the fisherman that wears the fishing backpack.

An object of the present invention is to provide a functional, affordable, well built, and easy to use fishing backpack that overcomes the limitations or deficiencies of the cited references.

Other features and advantages are inherent in the backpack device claimed and disclosed will become apparent to those skilled in the art from the following detailed description and its accompanying drawings.

### BRIEF DESCRIPTION OF THE DRAWINGS

FIG. 1 is a back view of one embodiment of the fishing backpack.

FIG. 2 is a front view of one embodiment of the fishing backpack.

FIG. 3 is a perspective view of one embodiment of the fishing backpack.

FIG. 4 is a detailed front view of one embodiment of the fishing backpack and shows the liquid compartment.

### DETAILED DESCRIPTION OF THE DRAWINGS

In the following detailed description of the preferred embodiment, reference is made to the accompanying drawings that form a part hereof, and in which is shown, by way of illustration, a specific embodiment in which the invention may be practiced. It is to be understood that other embodiments may be utilized and structural changes may be made without departing from the scope of the present invention.

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

### DRAWINGS

### Reference Numerals

10 Fishing backpack
11 Food storage compartment
12 Shoulder pads
15 Frame
19 Primary tackle storage compartment
20 Secondary tackle storage compartment
25 Back pad
26 Side pad
27 Waist belt
28 Buckle
30 Support bars
31 Perpendicular support bar
35 Fishing rod holder/fishing rod cup
36 Fishing rod holder/fishing rod cup
40 Clasp/Fishing rod clasp
45 Carrying handle
50 Liquid compartment
55 Flexible drinking tube
60 Mouthpiece/valve
61 Drinking tube clasp
74 Fishing net storage compartment connector
75 Fishing net storage compartment
76 Fishing net
80 Fishing pole/rod
81 Fishing reel
82 Fishing rod end
99 Side storage compartments
100 Side storage compartments
302 Food compartments

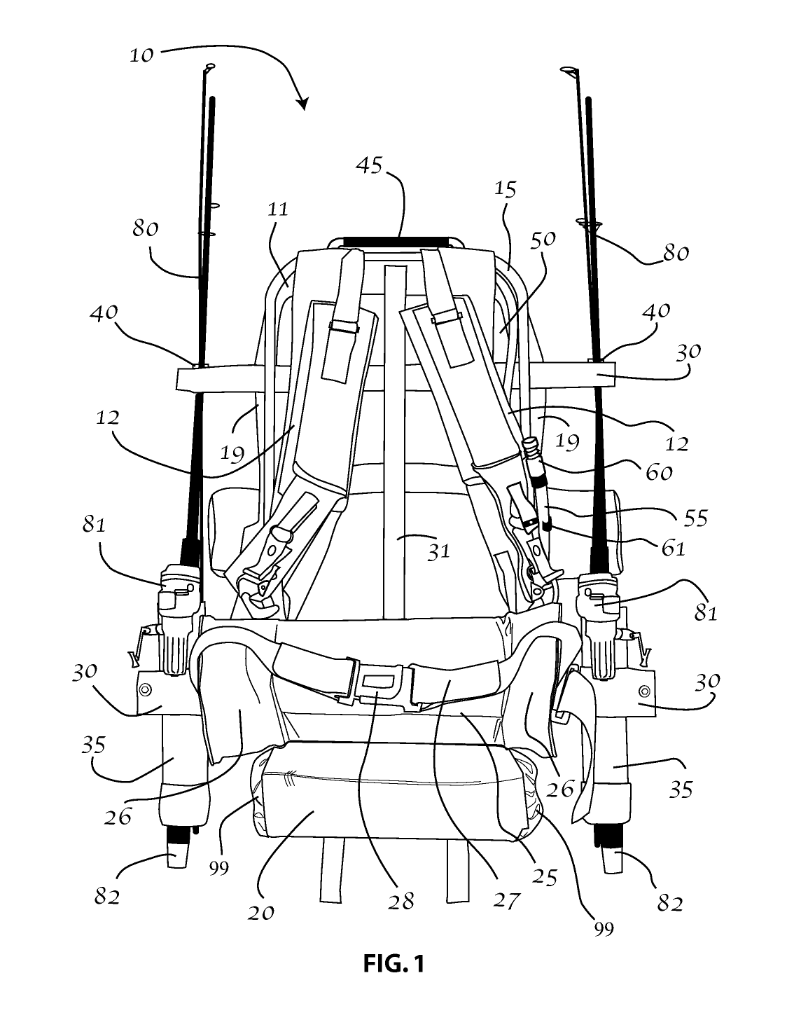

FIG. 1 is a back view of one embodiment of the fishing backpack. As shown in FIG. 1, the fishing backpack 10 preferably includes: food storage compartment 11; shoulder pads 12; frame 15; primary tackle storage compartment 19; secondary tackle storage compartment 20; back pad 25; side pads 26; waist belt 27; buckle 28; support bars 30; perpendicular support bar 31; fishing rod holder/fishing rod cup 35; fishing rod clasp 40; carrying handle 45; liquid compartment 50; flexible drinking tube 55; mouthpiece/valve 60; drinking tube clasp 61; and side storage compartments 99.

Backpack 10 is a compact and wearable pack that allows a fisherman to carry in a hands free manner everything needed for a fishing trip. This invention will preferably reduce the number of mishaps that can happen during a fishing trip, such as multiple trips or forgetting something important. The backpack 10 is designed to easily fit in the trunk of a car or in the cab of an automobile. The backpack 10 is preferably wearable by people of all shapes and sizes and can be made or designed specifically for men, women, children, armatures, or professionals. The backpack 10 is wearable during hiking, biking, motorcycling, or horseback riding.

FIG. 1 shows how the frame 15 outlines the backpack 10 so that the backpack 10 can be easily mounted on the back of a wearer. The frame 15 adds the much needed support for allowing much heavier carrying capacity. The back pad 25 and side pads 26 provide comfort and support to the wearer when wearing the backpack. Further support is provided through use of the waist belt 27, which is clipped on around the wearer using buckle 28.

FIG. 1 shows the support bars 30, which are preferably attached to or part of frame 15, provide attachment points for fishing rod holders 35 and fishing rod clasps 40. The fishing pole 80 and fishing reel 81 are placed into the fishing rod holders 35 and then the fishing pole 80 is clipped or slid into the fishing rod clasps 40. The fishing rod clasps 40 can be a spring loaded clip or clasp, as preferred, a tension clasp, a friction clasp, or any device that will allow a fishing pole to pass into a resting place, hole, or notch, and then hold the fishing pole securely in place. The clasps 40 also allow the user to safely, smoothly, and easily pull the rod free from the clasp 40 when the user wants to remove the fishing pole 80 from the backpack. FIG. 1 shows that there are preferably two fishing poles 80 held by backpack 10, but it should be understood that any number of poles 80 may be held and there may be any number of compartments.

FIG. 1 also shows the preferred placement of the drinking tube clasp 61. This way when the user gets thirsty, he or she can unhook or unclasp the drinking tube 55 from drinking tube clasp 61 and take a drink. Drinking tube 55 preferably has a mouthpiece/valve 60 that allows the user to control the flow of the liquid from liquid compartment 50. Liquid compartment 50 is preferably a two quart flexible and collapsible liquid reservoir that is refillable with any liquid. As the liquid is drank by a user, through drinking tube 55, the liquid compartment 50 collapses. Although liquid compartment 50 is preferably an integral part of backpack 10, it can be a separate and removable compartment.

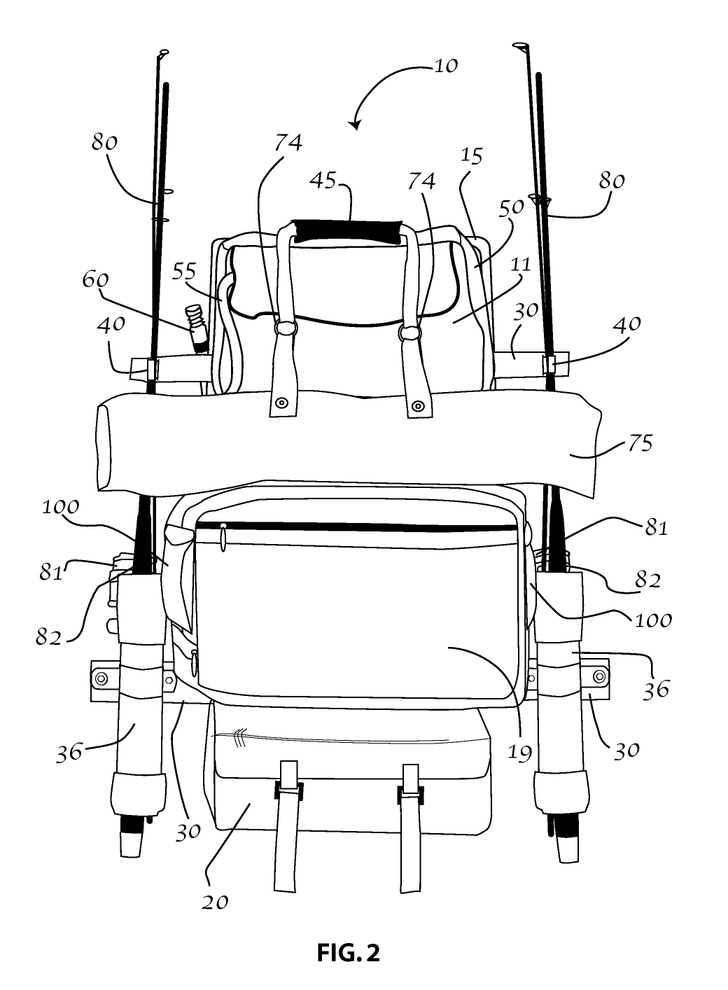

FIG. 2 is a front view of one embodiment of the fishing backpack. As shown in FIG. 2, the fishing backpack 10 preferably includes: food storage compartment 11; frame 15; primary tackle storage compartment 19; secondary tackle storage compartment 20; support bars 30; fishing rod cup 36; fishing rod clasp 40; carrying handle 45; liquid compartment 50; flexible drinking tube 55; mouthpiece/valve 60; drinking tube clasp 61; fishing net storage compartment connectors 74; fishing net storage compartment 75; fishing rod end 82; and side storage compartment 100. FIG. 2 shows how the many compartments of backpack 10 a separated and preferably positioned around backpack 10. The primary and secondary tackle storage compartments 19 and 20 are preferably in the lower portion of the backpack 10, food and liquid compartments 11 and 50 are preferably in the upper portion of the backpack, and the fishing net storage compartment 75 is preferably connects to the outside of the backpack through fishing net storage compartment connectors 74. In this way the fishing net storage compartment 75 is removable and attachable to backpack 10 and is easily accessible or moved out of the way.

FIG. 2 also shows how drinking tube 55 comes out of the top of backpack 10 from liquid compartment 50. Liquid compartment 50 and food compartment 11 are preferably compartments within backpack 10.

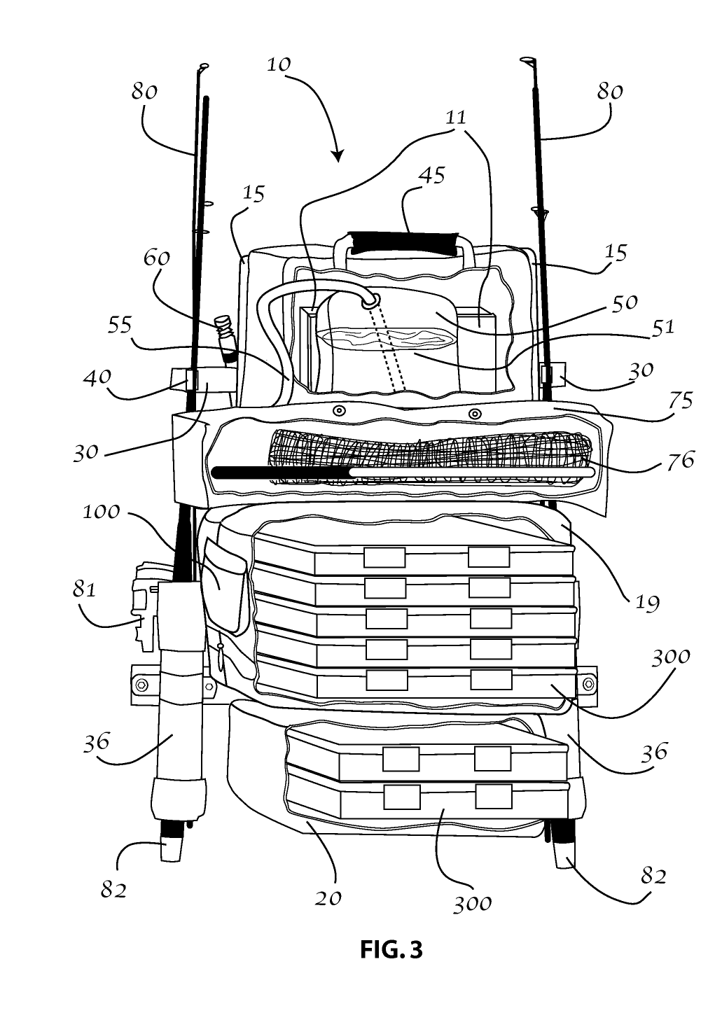

FIG. 3 is a perspective and cut away view of one embodiment of the fishing backpack. As shown in FIG. 3, the fishing backpack 10 preferably includes: food storage compartment 11; frame 15; primary tackle storage compartment 19; secondary tackle storage compartment 20; support bar 30; fishing rod cup 36; fishing rod clasp 40; carrying handle 45; liquid compartment 50; liquid 51; flexible drinking tube 55; mouthpiece/valve 60; drinking tube clasp 61; fishing net storage compartment connectors 74; fishing net storage compartment 75; fishing rod end 82; and side storage compartment 100. In FIG. 3, the tackle storage compartments 19 and 20, the fishing storage compartment 75, and the upper storage compartment, which contains food storage compartment 11 and liquid compartment 50, are show in cutaway view so that the interior of the compartments are visible. FIG. 3 shows how the fishing net storage compartment 75 preferably holds a collapsible fishing net 76. FIG. 3 also shows the liquid storage container 50 holds a liquid 51, which is preferably a potable water, but may be any other liquid. FIG. 3 shows how the tackle storage compartments 19 and 20 preferably hold various types of tackle boxes 300. FIG. 3 shows how the drinking tube 55 is part of liquid compartment 50 and allows the user to access liquid 51.

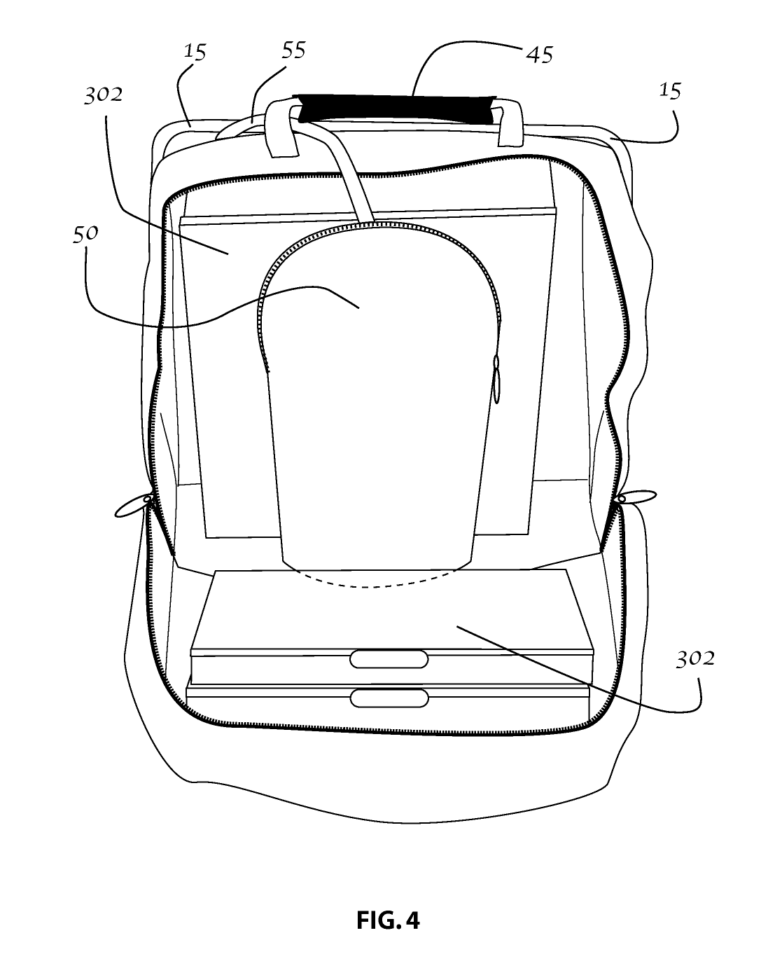

FIG. 4 is a detailed front view of one embodiment of the fishing backpack and shows the liquid compartment inside the fishing backpack. FIG. 4 shows the upper front portion of the back pack when it is unzipped and the liquid compartment 50 and food compartments 302 are visible. FIG. 4 also shows how the fishing backpack 10 preferably includes a frame 15, carrying handle 45, and drinking tube 55. Preferably liquid compartment 50 is fixedly integrated to the interior of the fishing backpack 10, but it may be removable and re-attachable without deviating from the scope of the invention.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

What is claimed is:

1. A fishing backpack comprising:
a backpack;
wherein said backpack is comprised of one or more shoulder straps; a rigid frame; one or more storage compartments, and one or more fishing rod holders.

2. The fishing backpack of claim 1, wherein said backpack is further comprised of:
one or more fishing rod clasps;
wherein said one or more fishing rod holders secure a fishing rod base of a fishing rod and wherein said one or more fishing rod clasps secure an upper portion of said fishing rod.

3. The fishing backpack of claim 2, wherein said one or more storage compartments are further comprised of:
a primary tackle storage compartment;
a food storage compartment;
a bulk liquid storage compartment.

4. The fishing backpack of claim 3, wherein said backpack is further comprised of:
a net storage compartment;
wherein said net storage compartment is removable from and reattachable to said backpack.

5. The fishing backpack of claim 4, wherein said bulk liquid storage compartment is further comprised of:
one or more drinking tubes;
wherein said one or more drinking tubes have a valve that allows a user to control access to a liquid in said bulk liquid storage compartment.

6. The fishing backpack of claim 5, wherein said backpack is further comprised of:
one or more drinking tube clasps.

7. The fishing backpack of claim 6, wherein said drinking tube clasp is attached to said one or more shoulder straps.

8. The fishing backpack of claim 5, wherein said backpack is further comprised of:
a lower back support; and
a waist belt;
wherein said waist belt secures said backpack to said user.

9. The fishing backpack of claim 5, wherein said rigid frame is further comprised of:
one or more support bars;
wherein said one or more support bars are on a back side of said backpack and provide rigid support for said backpack.

10. The fishing backpack of claim 5, wherein said one or more fishing rod clasps are tension and friction clasps and are fixedly attached to said rigid frame such that said user may snap said fishing rod into and out of said one or more fishing rod clasps.

11. The fishing backpack of claim 5, wherein said one or more storage compartments are further comprised of:
one or more secondary tackle compartments; and
one or more side compartments.

12. The fishing backpack of claim 5, wherein said backpack is further comprised of:
a carrying handle.

13. A fishing backpack comprising:
a backpack;
wherein said backpack is comprised of one or more shoulder straps; a rigid frame; one or more storage compartments; one or more fishing rod holders; one or more fishing rod clasps; a net storage compartment; one or more drinking tubes; one or more drinking tube clasps; a lower back support; a waist belt; one or more support bars; and a carrying handle;
wherein said one or more fishing rod holders secure a fishing rod base of a fishing rod and wherein said one or more fishing rod clasps secure an upper portion of said fishing rod;
wherein said one or more storage compartments are comprised of a primary tackle storage compartment; a food storage compartment; a bulk liquid storage compartment; one or more secondary tackle compartments; and one or more side compartments;
wherein said net storage compartment is removable from and reattachable to said backpack;
wherein said one or more drinking tubes have a valve that allows a user to control access to a liquid in said bulk liquid storage compartment;
wherein said drinking tube clasp is attached to said one or more shoulder straps;
wherein said waist belt secures said backpack to said user;
wherein said one or more support bars are on a back side of said backpack and provide rigid support for said backpack; and
wherein said one or more fishing rod clasps are tension and friction clasps and are fixedly attached to said rigid frame such that said user may snap said fishing rod into and out of said one or more fishing rod clasps.

14. A fishing backpack comprising:
a backpack;
wherein said backpack is comprised of one or more shoulder straps; one or more tackle storage compartments; one or more food storage compartments; one or more bulk liquid storage compartments; one or more fishing rod cups; and one or more fishing rod clasps;
wherein said one or more fishing rod cups secure a fishing rod base of a fishing rod and wherein said one or more fishing rod clasps secure an upper portion of said fishing rod.

15. The fishing backpack of claim 14, wherein said backpack is further comprised of:
a net storage compartment;
wherein said net storage compartment is removable from and reattachable to said backpack.

16. The fishing backpack of claim 15, wherein said bulk liquid storage compartment is further comprised of:
one or more drinking tubes;
one or more drinking tube clasps;
wherein said one or more drinking tubes have a valve that allows a user to control access to a liquid in said bulk liquid storage compartment;
wherein said drinking tube clasp is attached to said one or more shoulder straps.

17. The fishing backpack of claim 16, wherein said backpack is further comprised of:
a rigid frame;
one or more support bars;
wherein said rigid frame and said one or more support bars provide structure to said backpack.

18. The fishing backpack of claim 17, wherein said backpack is further comprised of:
a lower back support; and
a waist belt;
wherein said waist belt secures said backpack to said user.

19. The fishing backpack of claim 18, wherein said backpack is further comprised of:
a carrying handle.

20. The fishing backpack of claim 19, wherein said one or more fishing rod clasps are tension and friction clasps and are fixedly attached to said rigid frame such that said user may snap said fishing rod into and out of said one or more fishing rod clasps when said fishing rod is in said one or more fishing rod cups.
